(19) United States
(12) Patent Application Publication
(10) Pub. No.: US 2009/0300499 A1
(43) Pub. Date: Dec. 3, 2009

(54) INFORMATION PROCESSING APPARATUS

(75) Inventor: Kotaro FUKUI, Hamura-shi (JP)

Correspondence Address: KNOBBE MARTENS OLSON & BEAR LLP, 2040 MAIN STREET, FOURTEENTH FLOOR, IRVINE, CA, 92614, US

(73) Assignee: Kabushiki Kaisha Toshiba, Tokyo (JP)

(21) Appl. No.: 12/410,205

(22) Filed: Mar. 24, 2009

(30) Foreign Application Priority Data
Jun. 3, 2008 (JP) 2008-146121

(51) Int. Cl. G06F 3/00

(52) U.S. Cl. 715/722

(57) ABSTRACT

According to one embodiment, an information processing apparatus includes a display controller configured to generate a video signal of images including a moving picture, command transmitting and receiving module configured to transmit and receive the commands, detecting module configured to detect an event to change a display state of the moving picture from one of the full screen display and the window display to another, and outputting module configured to output a command to change a first display mode to a second display mode when the detecting module detects an event to change the window display to the full screen display, and outputting a command to change the second display mode to the first display mode when the detecting module detects an event to change the full screen display to the window display, the outputting module outputting the command through the connector via the command transmitting and receiving module.

### CROSS-REFERENCE TO RELATED APPLICATIONS

This application is based upon and claims the benefit of priority from Japanese Patent Application No. 2008-146121, filed Jun. 3, 2008, the entire contents of which are incorporated herein by reference.

### BACKGROUND

1. Field

One embodiment of the invention relates to an information processing apparatus having an image reproducing function, which allows a video signal to be transmitted to, for example, a television broadcast receiver.

2. Description of the Related Art

In general, image qualities of computer image display suitable for a PC monitor and for a television set are different.

Image qualities suitable for displaying a computer's state of displaying a document or the like and for displaying a computer's state of playing back a moving picture are also different. In the former case, an image quality which allows easy reading of letters is preferable. In the latter case, an image quality which allows display of a moving picture in colors close to the original is preferable.

Jpn. Pat. Appln. KOKAI Publication No. 2002-116736 discloses a technique of an LCD display apparatus having an image quality switching button. When a moving picture of an image of a DVD, television or the like is input to the apparatus disclosed in this publication, the display mode is switch to a higher brightness and color-corrected mode by a button operation by the user.

In the above-described technique, notice of information to output an image with a suitable image quality to the display apparatus is not taken into consideration. Therefore, when the user wishes to display an image in the display apparatus in a setting that matches the preference of the user, he or she needs to perform manual operations. The technique is inconvenient in this respect. Particularly when an image output from a computer is to be displayed in a television set, to display it in a suitable display condition, an operation of the television is required to change the display setting in addition to an application operation of the computer, for example, document or image reproduction. Thus, very complicated operations are required. Therefore, it is desirable to change an image quality without an operation by the user.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing an appearance of an image processing apparatus and a monitor according to an embodiment of the present invention;

FIG. 2 is an exemplary block diagram showing a system configuration of the image processing apparatus shown in FIG. 1;

FIG. 3A and FIG. 3B are exemplary diagrams for explaining a full screen mode and a window mode;

FIG. 4 is an exemplary block diagram showing functions relating to a mode detecting mechanism and a command transmission mechanism implemented in the information processing apparatus shown in FIG. 1;

FIG. 5 is an exemplary flowchart showing command transmission sequences involved in a mode switching operation executed by the information processing apparatus; and

FIG. 6 is an exemplary flowchart showing command transmission sequences involved in the mode switching operation executed by the information processing apparatus.

### DETAILED DESCRIPTION

Various embodiments according to the invention will be described hereinafter with reference to the accompanying drawings. In general, according to one embodiment of the invention, an information processing apparatus comprises playback module configured to play back a moving picture displayed in one of full screen display and window display, a display controller configured to generate a video signal of images including a moving picture played back by the playback module, a connector configured to output the video signal and input and output commands for operation control, command transmitting and receiving module configured to transmit and receive the commands via the connector, change event detecting module configured to detect an event to change a display state of the moving picture from one of the full screen display and the window display to another, and command outputting module configured to output a command to change a first display mode to a second display mode when the change event detecting module detects an event to change the window display to the full screen display, and outputting a command to change the second display mode to the first display mode when the change event detecting module detects an event to change the full screen display to the window display, the command outputting module outputting the command through the connector via the command transmitting and receiving module.

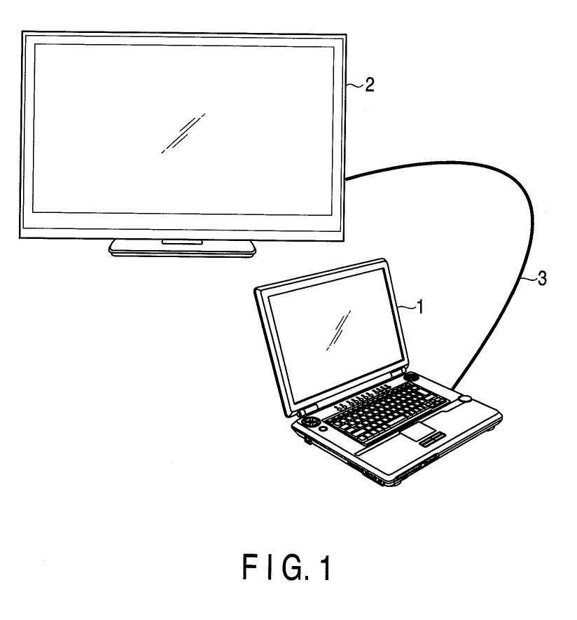

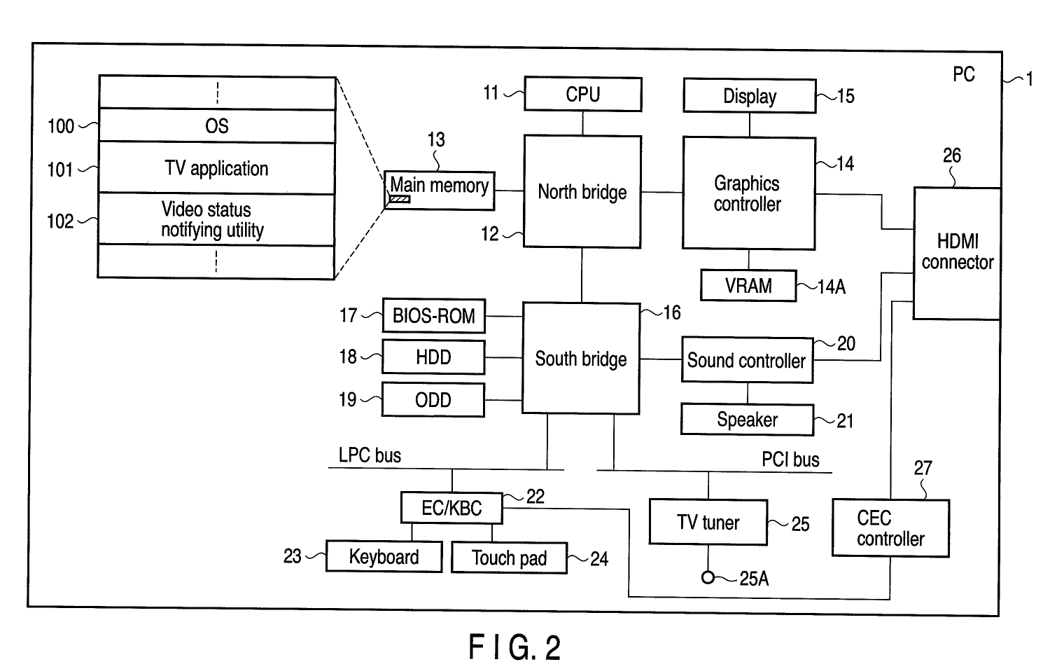

An information processing apparatus according to the embodiment of the present invention will be described with reference to FIGS. 1 and 2. The information processing apparatus is implemented as a notebook personal computer.

Configurations of a monitor (sink device) and information processing apparatus (source device) according to the embodiment of the present invention will be described with reference to FIG. 1.

The personal computer 1 is capable of recording and playing back video content data (audio visual content data), such as broadcast program data and video data input from an external apparatus. More specifically, the personal computer 1 has a television (TV) function to watch and record broadcast program data broadcasted by a television broadcast signal. The TV function is implemented by, for example, a TV application program preinstalled in the personal computer 1. The TV function also serves to record video data input from an external AV apparatus and play back recorded video data and recorded broadcast program data.

As shown in FIG. 1, it is assumed that the information processing apparatus 1 is connected to a monitor 2 through an HDMI (High-Definition Multimedia Interface) cable 3. The monitor 2 is a large-screen high-definition television receiver (TV). The information processing apparatus 1 contains various software (application programs) installed therein to play back high-definition image data. The user can enjoy a high-definition image played back by the application programs through the monitor 2. The information processing apparatus 1 and the monitor 2 connected by the HDMI cable 3 can transmit/receive various commands to/from each other to control operations of the counterpart.

FIG. 2 is a diagram showing a configuration of the information processing apparatus 1. As shown in FIG. 2, the information processing apparatus 1 comprises a CPU 11, a north bridge 12, a main memory 13, a graphics controller 14, a VRAM 14A, a display 15, a south bridge 16, a BIOS-ROM 17, an hard disc drive (HDD) 18, a optical disk drive (ODD) 19, a sound controller 20, a speaker 21, an embedded controller/keyboard controller (EC/KBC) 22, a keyboard 23, a touch pad 24, a TV tuner 25, an HDMI connector 26 and a CEC (consumer electronics control) controller 27, etc.

The CPU 11 is a processor which controls operations of the parts in the information processing apparatus 1. The CPU 11 executes various programs, which are loaded in the main memory 13 from the HDD 18. The programs include an operating system (OS) 100, and a utility (utility 102) and an application (TV application program 101) to deal with AV contents, which are operated under the control of the OS 100. The OS 100 has a window system to display a plurality of windows on a display screen.

The TV application program 101 is software to execute the TV function. The TV application program 101 executes a live playback process to watch broadcast program data received by the TV tuner 25, a record process to record the received broadcast program in the HDD 18 and a playback process to play back the broadcast program data or video data recorded in the HDD 18.

One of the utilities executed by the CPU 11 is a video status notifying utility 102, which will be described later. The CPU 11 also executes a basic input/output system (BIOS) stored in the BIOS-ROM 17. In the following descriptions, the basic input/output system stored in the BIOS-ROM 17 may be referred to as “BIOS 17”.

The north bridge 12 is a bridge device which connects a local bus of the CPU 11 and the south bridge 16. The north bridge 12 has a function of executing communication with the graphics controller 14 via a bus, and incorporates a memory controller which controls access to the main memory 13. The graphics controller 14 is a display controller which controls the display 15 in the information processing apparatus 1. The graphics controller 14 generates a video signal to be transmitted to the display 15 from image data written in the VRAM 14A. The graphics controller 14 also has a function of externally outputting the video signal through the HDMI connector 26.

The south bridge 16 is a controller which controls various devices on a PCI bus and an LPC bus. The south bridge 16 is directly connected to the BIOS-ROM 17, the HDD 18, the ODD 19 and the sound controller 20 and controls these components. The HDD 18 stores, for example, television broadcast program data and AV contents downloaded via the Internet. The ODD 19 contains, for example, a DVD storing AV contents. The sound controller 20 is a sound source controller which controls the speaker 21. The sound controller 20 also has a function of externally outputting a sound signal through the HDMI connector 26.

The EC/KBC 22 is a 1-chip microcomputer, in which an embedded controller to manage power and a keyboard controller to control the keyboard 23 and the touch pad 24 are integrated.

The HDMI connector 26 is a terminal provided to removably connect the HDMI cable 3. The CEC controller 27 executes data transfer control to transmit and receive various commands for operation control via the HDMI connector 26 under the control of the EC/KBC 22.

The TV tuner 25 is a receiver which is connected to an antenna terminal 25A and receives broadcast program data broadcasted by a television (TV) broadcast signal. The TV tuner 25 is implemented as a digital TV tuner configured to receive digital broadcast program data such as terrestrial digital TV broadcasting. The TV tuner also has a function of capturing video data input from an external apparatus.

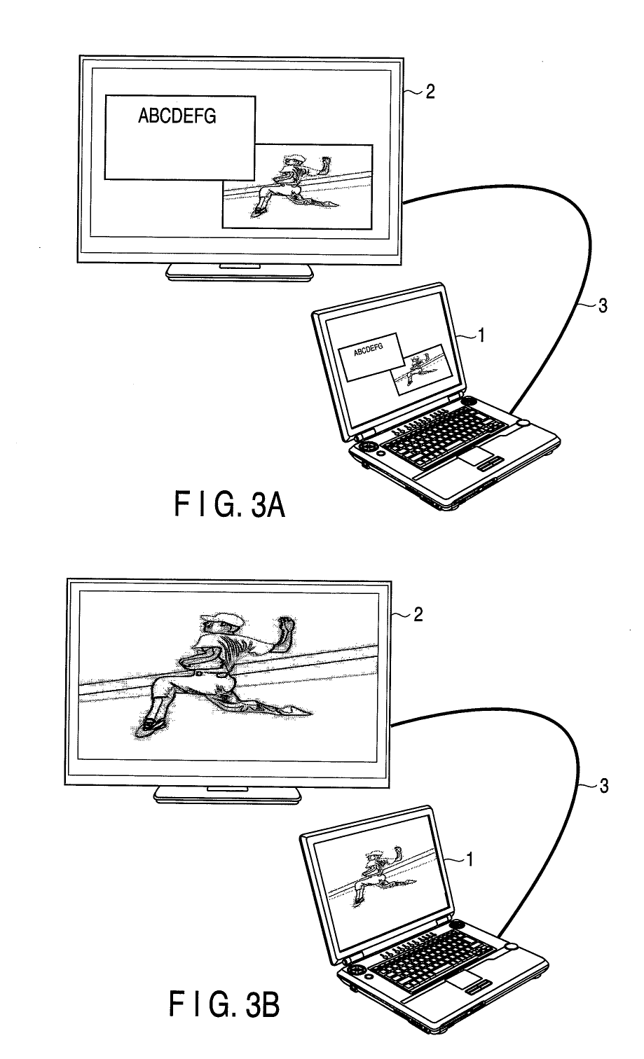

A moving picture displayed by the TV application program 101 is generally displayed in a window corresponding to the TV application program 101. In this case, as shown in FIG. 3A, for example, the window corresponding to the TV application program 101 is arranged on the desktop screen and the moving picture is displayed in the screen (a window mode). Thus, in the case of display in the window mode, a text or the like of a document application can also be displayed.

The computer 1 can also display a moving picture on a display screen of the display 15 in a full screen (a full screen mode). In the full screen mode, as shown in FIG. 3B, only the moving picture is displayed in almost all area of the display screen of the display. In this case, the desktop screen and any window that corresponds to an application program other than a video playback application program is not basically displayed. A menu bar or the like of the window corresponding to the video playback application program is also not displayed; only the moving picture is displayed in almost all area of the display screen.

It is assumed that a video signal is transmitted from the computer 1 through the HDMI cable 3 to display an image based on the video signal in the monitor 2. In this case, a video signal of an image generated in either the full screen mode or the window mode is transmitted to the monitor 2.

For example, if a moving picture is to be displayed in the monitor 2, it is preferable to change the quality of the image in the monitor 2 such that the image can be displayed in an image quality status suitable for moving picture display. However, in the case where an image including a text is displayed, the text portion may not be clear but hard to read in the image quality status suitable for the moving picture display.

This drawback may be avoided by setting image quality that allows a moving picture to be displayed in original colors in the case where information output from the computer 1 is a video signal in the full screen mode, and setting image quality that allows letters to be easily read in the case where the information is a video signal in the window mode. However, it is impossible to detect on the side of the monitor 2 whether the received video signal has been generated in the window mode or the full screen mode on the side of the computer 1. Therefore, the computer 1 according to the present invention transmits a command indicating that the video signal has been generated in the window mode or the full screen mode through the CEC controller 27, and requests the monitor 2 to change the image quality. The monitor 2 adjusts the image quality of the video signal in accordance with the command transmitted from the computer 1.

In this embodiment, it is assumed that the image quality that allows a moving picture to be displayed in original colors adapted for the full screen mode (second display mode) and the image quality that allows letters to be easily read adapted for the window mode (first display mode) are determined on the basis of parameters set at the shipment. However, the parameters may be set suitably by the user through adjustment of the image quality as he or she desires.

Further, the computer 1 including the TV tuner 25 does not always display a moving picture even in the full screen mode. It may display a program table obtained from meta-data which the TV tuner receives or a content list stored in the HDD 18. In this case, the monitor 2 sets the image quality to the window mode (first display mode) that allows a text to be displayed clearly.

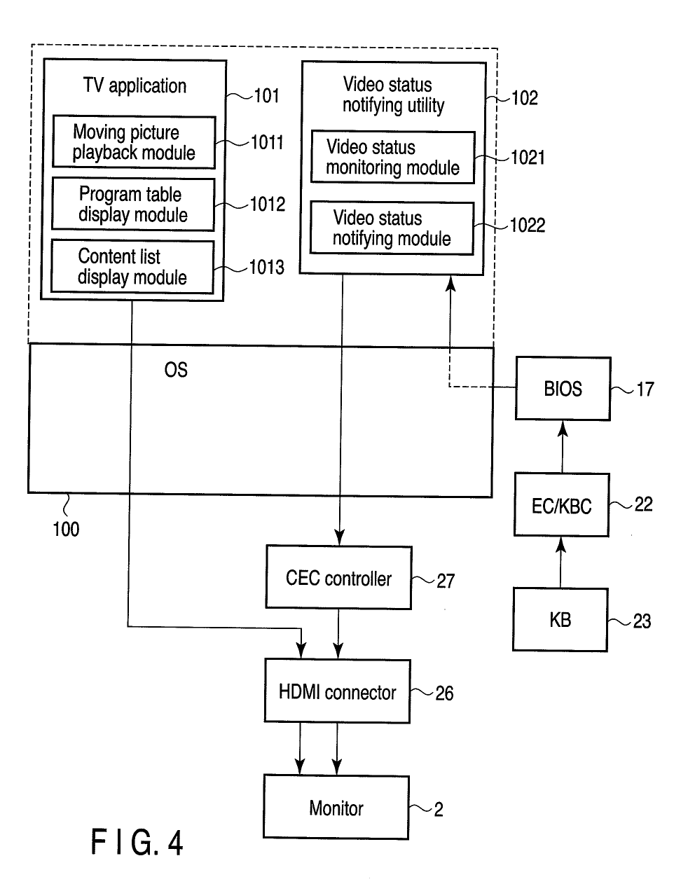

The following is a description on mechanism for detecting and transmitting a mode of the computer 1. FIG. 4 is a block diagram showing configurations of a mode detecting mechanism and a command transmission mechanism according to the embodiment of the present invention.

For example, when an operation for switching one of the window mode and the full screen mode to the other or an operation for switching between display and non-display of the program table is performed by means of the keyboard 23, a key code corresponding to the keyboard operation is generated by the EC/KBC 22 and transferred to the OS 100 via the BIOS 17.

The video status notifying utility 102 is a program to notify the monitor 2 of a mode status using the CEC controller 27 in association with a mode change, when one of the window mode and the full screen mode is switched to the other. The video status notifying utility 102 is registered as a resident program which always operates while the information processing apparatus 1 is powered on.

The resident program, video status notifying utility 102 has a video status monitoring module 1021 and a video status notifying module 1022. The video status monitoring module 1021 detects an activation status of the TV application program 101, and detects a mode change when the activation is detected.

When the mode change is detected, the video status notifying module 1022 instructs the CEC controller 27 to transmit the new mode to the monitor 2. The video status notifying module 1022 instructs the CEC controller 27 to transmit a command corresponding to the instructed mode to the monitor 2. The CEC controller 27 transmits one of two mode commands: one is a full screen moving picture mode command indicating that the moving picture is displayed in the full screen mode; and a window mode command indicating that the moving picture is not displayed in the full screen mode.

When the monitor 2 receives the full screen moving picture mode command, it changes the image quality setting to the second display mode suitable for playback of a moving picture. When the monitor 2 receives the window mode command, it changes the image quality setting to the first display mode suitable for reading a document or the like.

The TV application program 101 of this embodiment has a moving picture playback module 1011 to play back a moving picture from broadcast program data received via the TV tuner 25, a program table display module 1012 and a content list display module 1013.

The program table display module 1012 is a module to execute functions of acquiring and displaying an electronic program table, for example, through the TV tuner 25. The content list display module 1013 is a module to execute functions of reading information relating to contents stored in, for example, the HDD 18 and displaying the content list.

The video status monitoring module described before detects not only the display mode (the full screen mode or the window mode) of the TV application 101 but also an event, such as output of a video signal of the moving picture played back by the moving picture playback module 1011, or output of the program table or the content list produced by the program table display module 1012 or the content list display module 1013.

Even in the case where an image generated by the TV application program 101 is displayed, if the image is the television program table or the content list, it is preferable that the monitor 2 should be set such that letters can be easily read. Therefore, according to this embodiment, when the program table or the content list is displayed (when a moving picture is not played back), the video status monitoring module 1021 detects the event and the video status notifying module 1022 transmits the command (window mode command) to change the display mode of the monitor 2 from the second display mode to the first display mode.

Further, in this embodiment, when it is necessary to instruct the CEC controller 27 to transmit the new mode to the monitor 2, the instruction may be given from the TV application program 101, a program table display program 103 or a content list display program 104 instead of the video status notifying utility 102.

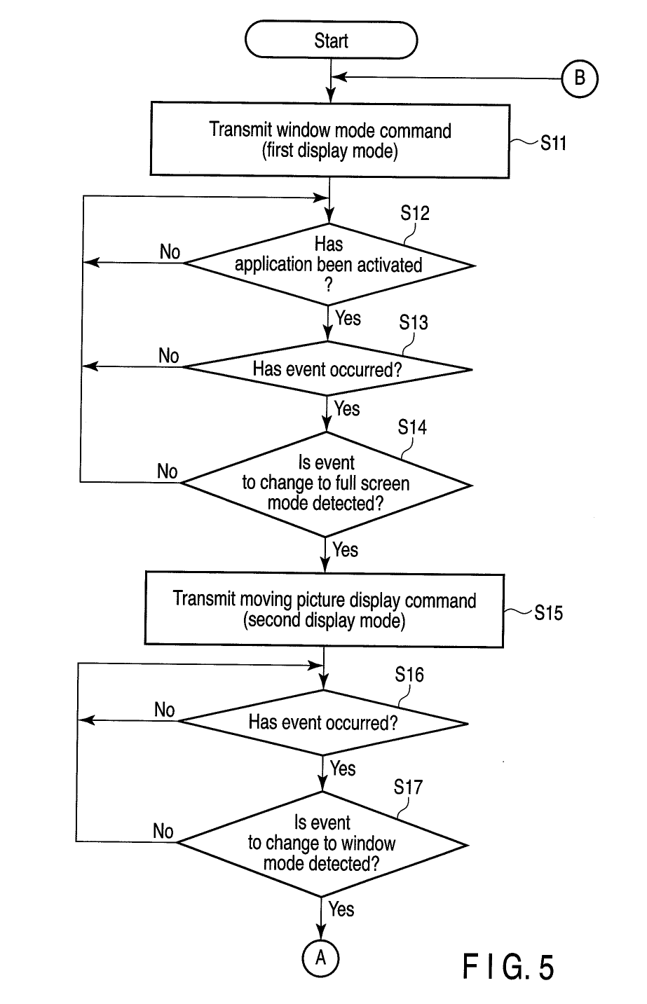

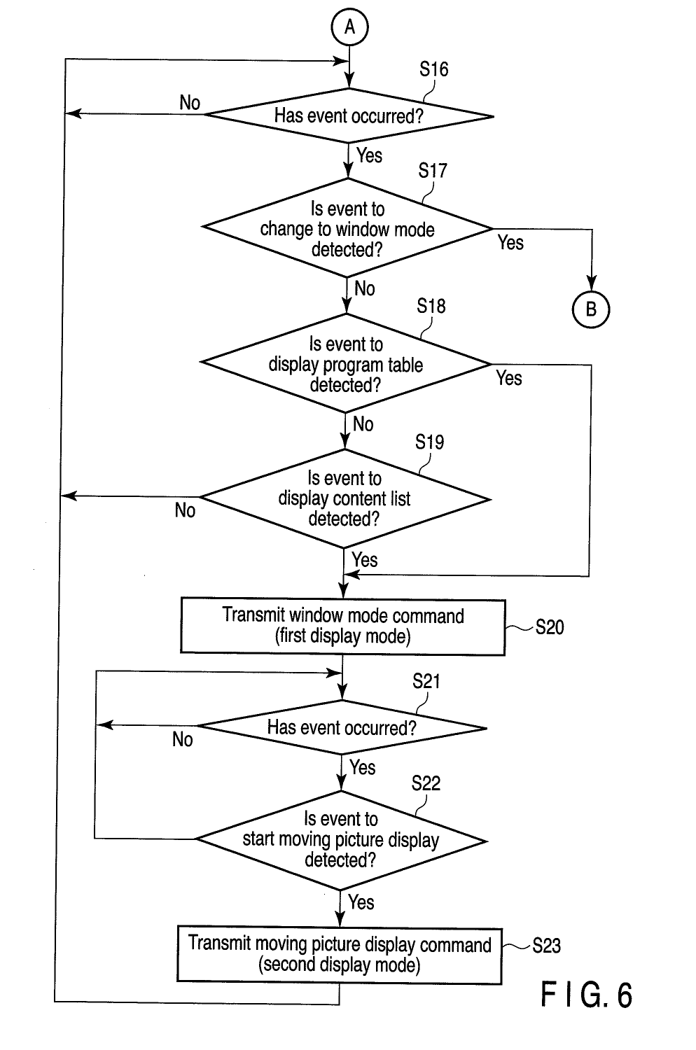

FIGS. 5 and 6 are flowcharts showing sequences of command transmission involved in the mode switching operation executed by the information processing apparatus 1 of this embodiment. The following is a description on a process that is executed while the computer 1 and the monitor 2 are connected by the HDMI cable 3.

When the computer 1 is booted and the video status notifying utility 102 is activated, the other application programs, such as the TV application program 101, have not been activated at that time. In this state, the video status notifying module 1022 instructs the CEC controller 27 to send the window mode command (the command to cause the monitor 2 to display an image in the first display mode) to the monitor 2. The CEC controller 27 sends the window mode command to the monitor 2 (block S11).

Then, the video status monitoring module 1021 detects whether the TV application program 101 has been activated or not (block S12). If it determines that the TV application program 101 has not been activated (No in block S12), it executes the process of block S12 periodically to check activation of the TV application program.

If the video status monitoring module 1021 determines that the TV application program 101 has been activated (Yes in block S12), it detects whether an event has occurred or not (block S13). If it determines that no event has occurred (No in block S13), the process returns to block S12.

If the video status monitoring module 1021 determines that an event has occurred (Yes in block S13), it discriminates whether the event that has occurred is an event to change the window mode to the full screen mode or not (block S14). If it determines that the event is not an event to change the window mode to the full screen mode (No in block S14), the process returns to block S12. If the video status monitoring module 1021 determines that the event is an event to change the window mode to the full screen mode (Yes in block S14), it instructs the video status notifying module 1022 to make the CEC controller 27 transmit the full screen moving picture mode command (the command to cause the monitor 2 to display an image in the second display mode) to the monitor 2. In accordance with the instruction, the CEC controller 27 transmits the full screen moving picture mode command to the monitor 2 (block S15).

After the transmission, the video status monitoring module 1021 detects whether a further event has occurred or not (block S16). If the video status monitoring module 1021 determines that no event has occurred (No in block S16), the process returns to block S16. If the video status monitoring module 1021 determines that an event has occurred (Yes in block S16), it discriminates whether the event that has occurred is an event to change to the full screen mode to the window mode or not (block S17). The events to change the full screen mode to the window mode include an event to terminate the TV application program 101. If it is determined that the event that has occurred is an event to change the full screen mode to the window mode (Yes in block S17), the video status notifying module 1022 returns the process to block S11 and instructs the CEC controller 27 to send the window mode command (the command to cause the monitor 2 to display an image in the first display mode) to the monitor 2.

If it is determined that the event that has occurred is not an event to change to the full screen mode to the window mode (No in block S17), the video status monitoring module 1021 discriminates whether the event that has occurred is an event to display the program table or not (block S18). If the video status monitoring module 1021 determines that the event that has occurred is not an event to display the program table (No in block S18), it discriminates whether the event is an event to display the content list stored in the HDD 18 (block S19).

Even in the case where the TV application program 101 is displayed in the full screen mode, if it is determined that the event is to display the program table in block S18 (Yes in block S18), the video status notifying module 1022 instructs the CEC controller 27 to transmit to the monitor 2 the window mode command indicating that an image signal in the window mode is being transmitted (the command to cause the monitor 2 to display the image in the first display mode). In accordance with the instruction, the CEC controller 27 transmits the window mode command to the monitor 2 (block S20). Likewise, even in the case where the TV application program 101 is displayed in the full screen mode, if it is determined that the event is to display the content list (Yes in block S19), the video status notifying module 1022 instructs the CEC controller 27 to transmit to the monitor 2 the window mode command indicating that an image signal in the window mode is being transmitted (the command to cause the monitor 2 to display the image in the first display mode). In accordance with the instruction, the CEC controller 27 transmits the window mode command to the monitor 2 (block S20).

Then, after the transmission, the video status monitoring module 1021 detects whether a further event has occurred or not (block S21). If it determines that no event has occurred (No in block S21), the process returns to block S21. If the video status monitoring module 1021 determines that an event has occurred (Yes in block S21), it determines whether the event that has occurred is an event to terminate the display of the program table or the content list and start display of a moving picture (block S22). If it determines that the event that has occurred is not an event to terminate the display of the program table or the content list and start display of a moving picture (No in block S22), the process returns to block S21.

If the video status monitoring module 1021 determines that the event that has occurred is an event to terminate the display of the program table or the content list and start display of a moving picture (Yes block S22, where it is assumed that the TV application program 101 is displayed in the full screen mode), the video status monitoring module 1021 instructs the CEC controller 27 to transmit the full screen moving picture mode command (the command to cause the monitor 2 to display an image in the second display mode) to the monitor 2. In accordance with the instruction, the CEC controller 27 transmits the full screen moving picture mode command to the monitor 2 (block S23). Then, the video status monitoring module 1021 sequentially executes the process in block S16 and the subsequent steps.

Through the process as described above, the computer 1 can transmits a command corresponding to the content of the image displayed in reply to an image signal. The monitor 2 receives the command transmitted from the computer, and when displaying an image signal received through the HDMI cable 3, it displays the image in a suitable image quality corresponding to the received command.

In the above description, the TV application program 101 which displays a broadcast program received through the TV tuner 25 is described as an example of the program to display a moving picture. However, the present invention may be applied to, instead of the TV application program 101, a program for reading information of a content recorded in an optical disk such as a DVD and displaying the content based on the read information. Further, in the embodiment described above, the computer 1 and the monitor 2 are connected by the HDMI cable, but they may be connected by a DisplayPort cable.

In the above embodiment, the moving picture playback application notifies the monitor 2 of a status via the notifying application through the HDMI, but the moving picture playback application may directly notify the TV of the status.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a playback module configured to play a moving picture displayed in either a full screen or a window;
a display controller configured to generate a video signal of images comprising a moving picture played by the playback module;
a connector configured to output the video signal, and to input and output a control command;
a command transmitter and receiver configured to transmit and receive the control commands via the connector respectively;
an event switch detecting module configured to detect an event in order to switch a display state of the moving picture from displaying in either a full screen or the window to displaying in either the window or a full screen, respectively; and
a switch command issuing module configured to issue a command in order to switch from a first display mode to a second display mode when the event switch detecting module detects an event in order to switch from displaying in the window to displaying in the full screen, and to issue a command in order to switch from the second display mode to the first display mode when the event switch detecting module detects an event in order to switch from displaying in the full screen to displaying in the window, the switch command issuing module issuing the command through the connector via the command transmitter and receiver.

2. The information processing apparatus of claim 1, wherein:
the event switch detecting module is configured to detect that playback of the moving picture is stopped; and
the switch command issuing module is configured to issue the command in order to switch from the second display mode to the first display mode through the connector via the command transmitter and receiver, when the event switch detecting module detects that the playback of the moving picture is stopped.

3. The information processing apparatus of claim 2, wherein:
the playback module is configured to generate an image different from the moving picture and to display the generated image when the playback of the moving picture is stopped;
the event switch detecting module is configured to detect an event in order to display the image when the moving picture is displayed in the full screen; and
the switch command issuing module is configured to issue the command in order to switch from the second display mode to the first display mode through the connector via the command transmitter and receiver, when the event switch detecting module detects the event in order to display the image.

4. The information processing apparatus of claim 3, further comprising a receiving device configured to receive broadcast program data,
wherein the playback module comprises a function of playing a moving picture from the broadcast program data received by the receiving device and a function of storing a broadcast program received by the receiving device as a content in a storage device.

5. The information processing apparatus of claim 4, wherein the image generated by the playback module is at least one of a program table generated from meta-data received by the receiving device and a list of contents stored in the storage device.

6. The information processing apparatus of claim 5, wherein the switch command issuing module is configured to issue the command in order to switch from the second display mode to the first display mode through the connector via the command transmitter and receiver, when the event switch detecting module detects an event in order to switch from displaying in the window to displaying in the full screen.

7. The information processing apparatus of claim 6, further comprising a driving module configured to drive a storage medium,
wherein the playback module is configured to play a moving picture from video data read out of the storage medium by the driving module.

8. The information processing apparatus of claim 7, wherein the connector detachably connects a High-Definition-Multimedia Interface (HDMI) cable.

9. An information processing apparatus comprising:
a playback application program stored in a computer readable medium configured to play a moving picture displayed in either full screen display or window display;
a display controller configured to generate a video signal of images comprising the moving picture;
a connector configured to output the video signal and to input and output a control command;
a event switch detecting module configured to detect an event in order to switch a display state of the playback application program from either displaying in the full screen or displaying in the window to either displaying in the window or displaying in the full screen, respectively; and
a switch command issuing module configured to issue a command in order to switch from a first display mode to a second display mode when the event switch detecting module detects an event in order to switch from displaying in the window to displaying in the full screen, and to issue a command in order to switch from the second display mode to the first display mode when the event switch detecting module detects an event in order to switch from displaying in the full screen to displaying in the window, the switch command issuing module issuing the command through the connector.

10. The information processing apparatus of claim 9, wherein:
the event switch detecting module is configured to detect that playback of the moving picture is stopped; and
the switch command issuing module is configured to issue the command in order to switch from the second display mode to the first display mode through the connector, when the event switch detecting module detects that the playback of the moving picture is stopped.

11. The information processing apparatus of claim 10, further comprising a receiving device configured to receive broadcast program data, wherein
the event switch detecting module is configured to detect a program table using meta-data received by the receiving device and generated by the playback application program; and
the switch command issuing module is configured to issue the command in order to switch from the second display mode to the first display mode through the connector when the event switch detecting module detects the generated program table.
